(19) United States
(12) Patent Application Publication
(10) Pub. No.: US 2015/0093305 A1
(43) Pub. Date: Apr. 2, 2015

(54) DEVICE FOR HANDLING FLUIDS

(71) Applicant: Robert Bosch GmbH, Stuttgart (DE)

(72) Inventors: Juergen Steigert, Stuttgart (DE); Martina Daub, Weissach (DE); Melanie Hoehl, Ditzingen (DE)

(21) Appl. No.: 14/498,769

(22) Filed: Sep. 26, 2014

(30) Foreign Application Priority Data
Sep. 27, 2013 (DE) 10 2013 219 492.7

(51) Int. Cl. B01L 3/00

(52) U.S. Cl. CPC B01L 3/5021; B01L 2300/0864; B01L 2400/0412; B01L 2400/0409
USPC 422/548

(57) ABSTRACT

A centrifugable device for handling fluids includes at least two bodies that are arranged axially one above the other. The at least two bodies each have at least one cavity that is configured to be fluidically coupled to the at least one cavity of the other body. The device further includes at least one fluid path, the orientation of which fluid path runs in a manner dependent on an acting Coriolis force.

This application claims priority under 35 U.S.C. §119 to patent application no. DE 10 2013 219 492.7, filed on Sep. 27, 2013 in Germany, the disclosure of which is incorporated herein by reference in its entirety.

### BACKGROUND

The present disclosure relates to a device for handling fluids, wherein the device has at least two bodies which are arranged axially one above the other and which each have at least one cavity, and wherein the bodies can be rotated relative to one another in a manner dependent on a centrifugal force or on an equivalent force, and wherein the cavities can be fluidically coupled to one another.

The execution of biochemical or chemical processes, for example in conjunction with the purification of particular molecules and/or the analysis and characterization of particular molecules, is based substantially on the handling of fluids. Conventionally, for this purpose, use is made of various implements, in particular pipettes and various reaction vessels, in order to be able to carry out the various processes by manual handling and with the aid of various laboratory appliances.

For many chemical or biochemical processes, centrifugation is used. Under the action of the centrifugal force generated here, it is possible to realize material separation owing to a difference in density between the different components of a mixture. Furthermore, centrifugation makes it possible for fluids to be transported from a process stage situated in the rotor radially further to the inside to a process stage situated radially further to the outside.

For many reactions, automation means are already available, wherein use is made for example of pipetting robots or other specialized appliances. Furthermore, numerous biochemical processes can be performed in a fully automatic manner with so-called lab-on-a-chip systems. These are microfluidic systems which combine the entire functionality of a macroscopic laboratory on a plastics substrate only approximately the size of a plastics card. Aside from the plastics substrate with various ducts, reaction chambers etc., upstream reagents and various active components, such as for example valves or pumps, and also further actuation, detection and control units, are required for this purpose.

Furthermore, cartridge-based systems are known in which the fluids are typically processed in a specialized appliance in a cartridge. For example, the German laid-open specification DE 10 2010 003 223 A1 describes a system having a device provided for use in a centrifugation rotor. Here, two or more revolver-like bodies are arranged axially one above the other. Here, the revolvers comprise one or more cavities, in particular reaction chambers, ducts and possibly further structures for the execution of processes, in particular of fluidic unit operations. A change in acceleration of the centrifuge activates an integrated mechanism which functions in the manner of a ballpoint pen mechanism. The centrifugal force causes the bodies to move radially outward, wherein the bodies are rotated relative to one another by means of a toothing and an integrated restoring means. Individual cavities can be connected to one another in this way. Furthermore, orientation-dependent opening of individual cavities or vessels of the bodies is possible, with one side of the vessel being provided, for example, with a pierceable foil. By means of a spike on the other body, the foil is pierced as a result of the movement of the bodies relative to one another. Controlled fluid guidance in the device can be achieved in this way. For example, it is possible to realize fluid guidance from pre-storage chambers via interposed processing chambers to collecting cavities for the processed fluids. Such a system may be utilized for example for the purification of biological or biochemical molecules. For this purpose, the sample and all reagents required for the purification are inserted in the uppermost revolver. The revolvers situated below serve as reaction stages for the various solid-phase or liquid-phase reactions. The transportation of the sample and reagents from the uppermost to the lowermost revolver takes place under the action of the centrifugal force of a standard laboratory centrifuge by virtue of the fluids being transported along the force vector of the centrifugal force from points situated radially at the inside to points situated radially at the outside.

The US patent application US 2006 073 082 A1 describes a centrifugable disk for handling fluids, in which a duct branch is provided. Switching of the fluids takes place in a manner dependent on an acting Coriolis force.

### SUMMARY

The device according to the disclosure serves for handling fluids, for example with regard to the execution of chemical and/or biochemical processes. Here, the disclosure is based on a centrifugable device which comprises at least two bodies which are arranged axially one above the other and which each have at least one cavity. The cavities can be fluidically coupled to one another. In particular, the disclosure is based on a stacked centrifugal system. For example, the bodies of the system may be rotatable or displaceable relative to one another in a manner dependent on a centrifugal force or on an equivalent force, such that a particular fluid path can be predefined in a manner dependent on the acting centrifugal force or on the equivalent force. The bodies are for example designed as revolvers. The revolvers may be combined in a device that is provided for use in the rotor of a centrifuge. Fluids are transported through the bodies arranged one above the other in a predefinable manner under the action of the centrifugal force or the equivalent force. This is in particular a microfluidic arrangement. According to the disclosure, in this device, at least one fluid path is provided, the orientation of which runs in a manner dependent on an acting Coriolis force. By means of a fluid path of said type, the mechanical and fluidic functionality of the generic device can be expanded and improved considerably. In particular in the case of the automation of complex biochemical processes, a multiplicity of functionalities are required which cannot be realized in the case of conventional, similar devices with switched fluid transportation owing to the limited possibilities for fluid paths. For example, in the case of a device based on the ballpoint pen mechanism described in the introduction, the number of fluid paths is limited owing to the fact that complex processes generally cannot be performed with such a device. The fluid path(s) provided according to the disclosure, which can be switched in a manner dependent on the acting Coriolis force, effectively increase(s) the number of possible fluid paths, and therefore such systems or devices can be used with much more complex protocols. By means of the fluid path provided according to the disclosure, it is thus possible, in devices with stacked bodies, for the effective number of fluid paths in the system to be increased. The path of the fluids can thus be adapted in a particularly advantageous manner to the planned automation process and to the centrifuging protocol.

In a particularly preferred refinement of the device according to the disclosure, the fluid path that is dependent on the Coriolis force acts as a fluid switch, wherein two or more alternative fluid path profiles are provided. For example, the device is designed such that the alternative fluid path profiles issue into different cavities of a body situated below as viewed in the flow direction. In this way, the fluid can be conducted into a particular cavity and in a manner dependent on the acting Coriolis force, whereby different processing protocols can be realized. For this switching effect, it is necessary for the centrifugal force to be varied just once to a value above a particular threshold value.

The orientation of the fluid path that is dependent on the Coriolis force may be independent of the rotation of the bodies or revolvers relative to one another. For example, the fluid path according to the disclosure may realize a connection between two bodies situated one above the other or a connection, and switching, between cavities within one body.

To realize the fluid switching according to the disclosure, a particular rotational speed must be attained. In general, it is the case that the magnitude of the Coriolis force (f_{Coriolis}) should be at least twice as great as the centrifugal force (f_{ω}). The required centrifugal speed can in particular be derived from the following formula:

$$\frac{\vert \text{?} Coriolis \vert}{\vert \text{?} \text{?} \vert} + \frac{ρ \cdot Δ {x}^{2} \cdot \text{?}}{4 \cdot η}$$

$$\text{?} \text{indicates text missing or illegible when filed}$$

where ρ is the density of the fluid, ω is the centrifugal speed (rad/s), η is the viscosity of the fluid, and Δx is the duct width. In the case of a duct width of, for example, Δx=200 μm, the Coriolis force becomes dominant at over 100 rad/s, such that, for the fluid switch according to the disclosure, at least 200 rad/s should be used. When the threshold at which the transversely acting Coriolis force becomes dominant is reached, the orientation of the fluid path is determined by the direction of the rotation. The diversion of the fluid path is in this case effected exclusively by the transversely acting Coriolis force. This effect can be utilized according to the disclosure to divert the fluid jet in a desired direction, and thus into a defined cavity.

The expression “fluid” used here is not restricted to media in the liquid state of aggregation. This is rather to be understood generally to mean a flowable medium which, aside from the liquid constituents, may also contain other, for example gaseous or solid constituents. Under some circumstances, the flowable medium may also be composed exclusively of solid constituents, for example of very fine-grain constituents.

The fluid path, the orientation of which is dependent on the acting Coriolis force, is preferably realized in the form of ducts. Said ducts have in particular a branched structure, wherein, for example, one inflow duct and two or more outflow ducts are provided. Owing to the direction of the acting centrifugal force during the processing of the fluids within the device according to the disclosure, the fluid passes firstly into the inflow duct. When a particular rotational speed threshold is reached, the acting Coriolis force becomes dominant, such that the fluid is diverted in a transverse direction in a manner dependent on the direction of rotation, and the fluid is diverted into the correspondingly oriented outflow duct. The duct structure may for example be in the form of an inverted Y-arrangement, with the upwardly directed inflow duct being situated opposite the two downwardly directed outflow ducts. In principle, it is possible to realize any desired number of arms, that is to say outflow ducts, which predefine the path of the fluids depending on the degree of the acting Coriolis force.

Aside from the implementation in the form of ducts, the fluid path that is dependent on the Coriolis force may for example also be in the form of an opening, with said opening being situated in particular in the lower region, as viewed in the flow direction, of a cavity. The fluid emerging from said opening is diverted in a particular direction in a manner dependent on the acting Coriolis force. This means that, when substantially no Coriolis force is acting, the fluid emerges in an axial direction. If the Coriolis force is acting or is dominant, the fluid is diverted transversely in a direction of rotation. Here, the direction of the Coriolis force is perpendicular both to the direction of movement of the body and also to the axis of rotation of the reference system, and acts counter to the direction of the centrifugation rotation. This can be utilized according to the disclosure to transfer the fluid into a particular cavity, which is situated in a corresponding position below the opening or offset with respect thereto, in a manner dependent on the acting Coriolis force.

Regardless of the form in which the fluid path is realized, it is possible for the fluid jet to be diverted into two or more different cavities in a manner dependent on the acting Coriolis force. It is furthermore possible for the fluids to be diverted into different cavities situated downstream in different proportions in a manner dependent on the acting Coriolis force. Here, the fluid streams may also be divided up in different ratios that are dependent on the acting forces. For example, the device may be configured such that the fluid stream is not entirely diverted by the Coriolis force, such that a distribution of the fluid stream into different cavities situated downstream can be realized.

Furthermore, the diversion according to the disclosure of the fluid stream in a manner dependent on the Coriolis force makes it possible to realize a separation of substances based on their density. For example, beads or other particles can be separated from a liquid, and concentrated if appropriate, by being diverted in different directions based on their density. This aspect of the disclosure is also suitable for example for the separation of the constituents of blood (blood cells and plasma) or of cells of different size.

The fluid switch according to the disclosure can be integrated in a variety of ways, and in different forms, into a device. For example, said fluid switch may be arranged in series and/or parallel. The duct structure for realizing the fluid switch according to the disclosure may take a wide variety of forms. For example, the duct arrangement may be symmetrical or asymmetrical. The branching points may for example be rounded or angled.

The device according to the disclosure with one or more fluid switches based on Coriolis force can be realized in a structurally simple manner. Particular advantages are that no further moving components, such as for example springs or the like, are required, and that the various bodies can for example all be manufactured from the same material, for example from rubber, polymers, glass, silicon, metals, plastics, thermoplastics (for example polyethylene (PE), polypropylene (PP), polycarbonate (PC), cyclic olefin copolymers (COC) or cyclic olefin polymers (COP)) or elastomers. The outer wall of the device, for example a centrifuge tube, may be manufactured from the same or a different material. The ducts within the device can be arranged in a space-saving manner. For the switching of the fluids in a manner dependent on Coriolis force, no pressure-tight connections are required because the fluids are both coupled in and coupled out in contactless fashion via the centrifugal field. A device of said type can thus be produced in a very inexpensive manner.

The fluid path which is dependent on the Coriolis force and which can be utilized as a fluid switch can in principle be integrated into all stacked fluidic systems based on centrifugal force. Said fluid path can particularly advantageously be used for example for stacked systems comprising at least two bodies which are arranged axially one above the other and which have suitable structures that can be rotated or displaced relative to one another in a manner dependent on a centrifugal force or on an equivalent force. The device according to the disclosure is particularly suitable for microfluidic systems.

The device according to the disclosure can be used advantageously for different applications. For example, said device can be used in particular for carrying out chemical and/or biochemical processes. Said device is suitable in particular for biochemical purification protocols or the like owing to the fact that the fluid switch that is based on Coriolis force can be used, for example, for carrying out a targeted elution of a target substance in a purification protocol. Alternatively, the extended functionalities of the device according to the disclosure can be utilized for detecting reaction products of an automated process or for monitoring purification steps in a purification protocol.

The fluid path switch according to the disclosure can advantageously be integrated in a device in which, for rotation of the bodies that are arranged axially one above one another, provision is made for guide springs of one body to engage into a profile tooth row on the other body, and of a restoring force, which acts counter to the centrifugal force or counter to the equivalent force, of the bodies. Such stacked systems based on centrifugal force, which are designed for example for microfluidic applications and are based on a so-called ballpoint pen mechanism, can already be used for various automated applications. By means of the fluid switch provided according to the disclosure, which is dependent on the acting Coriolis force, the functionalities and in particular the number of fluid paths that can be used in parallel in a system of said type are greatly increased, such that the enhancement, according to the disclosure, of a device of said type considerably improves the potential for use in a wide variety of protocols. On the other hand, it is also possible, through the use of the fluid switch according to the disclosure which is based on the Coriolis force, to partially or entirely dispense with other switch mechanisms in a stacked microfluidic device. For example, through the use of the fluid switch according to the disclosure, it is possible to provide a centrifugal system for automated processing of fluids which, with regard to functionalities, is similar to the centrifugal system described in the laid-open specification DE 10 2010 003 223 A1, but which partially or entirely dispenses with the relatively cumbersome ballpoint pen mechanism, whereby the costs for such a disposable article can be reduced considerably.

### BRIEF DESCRIPTION OF THE DRAWINGS

Further features and advantages of the device according to the disclosure will emerge from the following description of exemplary embodiments in conjunction with the drawings. Here, the individual features may each be realized individually or in combination with one another.

In the drawings:

FIG. 1 is a sectional illustration of a centrifugable device, with multiple revolvers that are rotatable relative to one another, from the prior art;

FIGS. 2A and 2B are schematic illustrations of revolvers that are rotatable relative to one another, with a fluid switch according to the disclosure;

FIGS. 3A-3C are detail illustrations of a duct structure as a fluid switch according to the disclosure;

FIGS. 4A and 4B are schematic illustrations of a further embodiment of the fluid switch according to the disclosure, and

FIGS. 5A and 5B are schematic illustrations of separation of solid particles by means of a fluid switch according to the disclosure.

### DETAILED DESCRIPTION

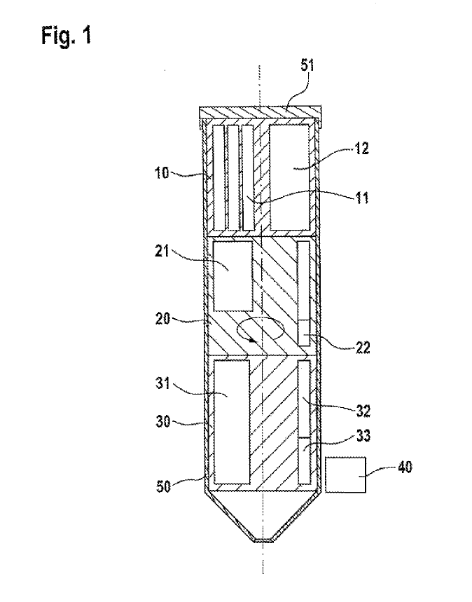

FIG. 1 schematically shows a system for the automatic processing of biochemical processes from the prior art, said system being based on multiple bodies (revolvers) 10, 20, 30 which are arranged axially one above the other and which are rotatable relative to one another. The bodies 10, 20, 30 comprise various cavities 11, 12, 21, 22, 31, 32, 33 which serve as vessels and reaction chambers. The device may be used for example for protein purification. Reagents are stored in the cavities 11. The sample is introduced into the cavity 12. The cavity 21 is a mixing chamber. The cavity 22 contains a matrix-based column with which the actual protein purification is performed. The cavity 31 is provided for the waste products. The eluate is collected in the cavity 32. In a subsequent reaction chamber 33, the filtered protein can be verified by way of a biochemical reaction, wherein use may be made of a detector 40 which is situated outside the device. The bodies 10, 20, 30 are situated in stacked fashion within a centrifuge tube 50 that can be closed off by means of a cover 51. The centrifuge tube 50 is inserted into the rotor of a laboratory centrifuge. The acting centrifugal forces cause the bodies 10, 20, 30 to rotate relative to one another in a predefined manner, in particular by way of an integrated ballpoint pen mechanism. The transportation of the sample and reagents from the uppermost revolver 10 to the lowermost revolver 30 takes place under the action of the centrifugal force. It may be provided here that spikes or the like on the bodies 20, 30 serve to open the cavities situated thereabove. The fluid flows in a predefined manner, such that the sample from the cavity 12 passes through the various processing steps in a predetermined manner.

The switching and the transportation of the fluids is in this case realized by way of the various fluid paths or delimited elution chambers within the revolvers 10, 20, 30. Here, however, the number of possible fluid paths is limited. By contrast, according to the disclosure, there is provision for permitting further switching of the fluids by virtue of at least one fluid path being provided, the orientation of which runs in a manner dependent on an acting Coriolis force.

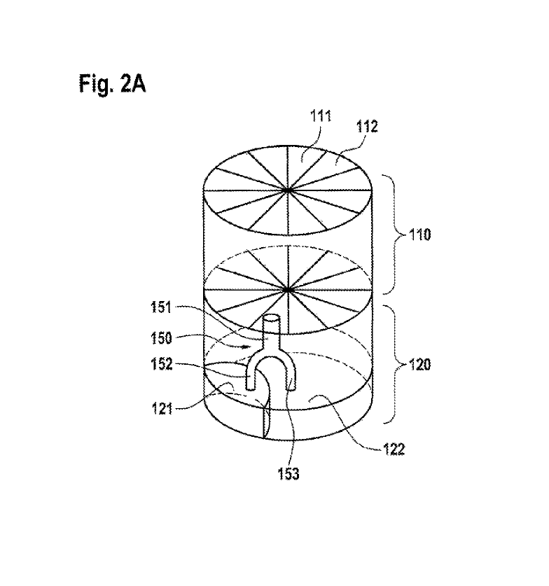

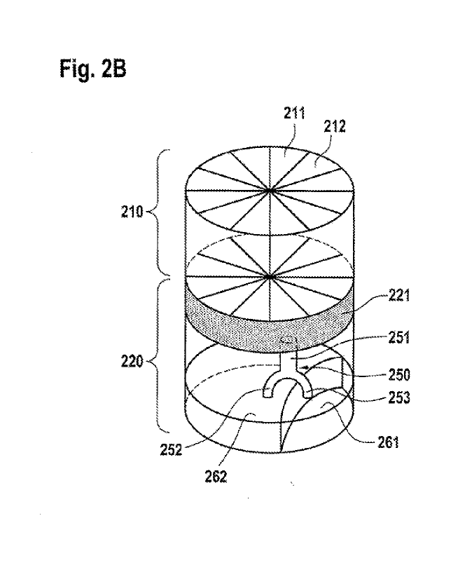

FIG. 2A and FIG. 2B illustrate exemplary embodiments of a fluid switch of said type, which is based on the action of Coriolis force. The fluid switches 150, 250 are realized by way of branched duct structures. FIG. 2A shows an upper revolver 110 and a downstream, lower revolver 120 which are rotatable relative to one another in a manner dependent on a centrifugal force. The revolver 110 comprises a total of eight cavities 111, 112, which are merely indicated here. The duct structure for the fluid switch that is dependent on Coriolis force is in the form of an inverted Y-arrangement 150. The duct structure 150 comprises an inflow duct 151 and two outflow ducts 152, 153. The duct structure 150 is situated in the upper region of the second revolver 120. The fluid within the duct structure 150 is diverted into one outflow duct 152 or the other outflow duct 153 in a manner dependent on the acting Coriolis force. Which of the ducts the fluid is diverted into is thus dependent on whether a particular threshold of the acting forces is exceeded. When a particular centrifugal speed, in particular in an acceleration range between 40 and 12,000×g, is reached, the transversely acting Coriolis force becomes dominant in relation to the radially acting centrifugal force, such that the fluid is diverted into a particular duct in a manner dependent on the direction of rotation. In the case of a duct width of Δx=200 μm, depending on the design of the system, the Coriolis force becomes dominant at for example over 100 rad/s, such that at least 200 rad/s should be set for the fluid switching according to the disclosure.

Different chambers (cavities) 121, 122 within the revolver 120 are situated below the outflow ducts 152, 153, such that the fluid is conducted into a particular chamber 121 or 122 in a manner dependent on the acting Coriolis force. The design shown here can be enhanced in a variety of ways. For example, the chambers 121, 122 may in principle have any desired number of compartments. Furthermore, it is for example possible for the chamber 121 to be designed as a mixing device which has two or more access ducts.

The fluid switch according to the disclosure can realize the connection between two revolvers or bodies, and/or the fluid switch can form the connection between multiple cavities within one revolver or body, as illustrated in exemplary fashion in FIG. 2B. Here, the fluid switch 250 according to the disclosure, which is again designed as a duct structure in the form of an inverted Y-arrangement, is situated within the second revolver 220. Above the second revolver 220 there is situated a first revolver 210 with a multiplicity of cavities 211, 212, which are merely indicated here. Fluids from the cavities 211, 212 of the revolver 210 pass into the chambers 221 of the revolver 220 in a manner dependent on the rotation of the revolvers 210 and 220 relative to one another. The chamber 221 is adjoined by the duct structure 250 according to the disclosure. The fluid firstly passes into the inflow duct 251 of the duct structure 250. In a manner dependent on the acting Coriolis force, the fluid is diverted into one of the two outflow ducts 252, 253 and is thus transferred into one of the chambers 262, 261 situated therebelow. In this way, it is possible, for example, for the eluate of a column purification process that takes place in the reaction chamber 221 to be collected in a particular chamber (261 or 262). The waste products from various binding and scrubbing steps can be collected in the respective other chamber (262 or 261). Here, it is possible for further switching steps of the revolvers relative to one another, for example by ballpoint pen mechanism, to be dispensed with. By means of the fluid switch according to the disclosure, it is thus possible overall for the number of required switching steps by rotation of the revolvers relative to one another to be reduced, such that overall, the switching possibilities are increased and more complex processes can be realized with the device according to the disclosure. Owing to the integration of the fluid switch according to the disclosure into a device provided for processing based on centrifugal force, it is also possible, if appropriate, to partially or entirely dispense with switching steps by ballpoint pen mechanism or other cumbersome mechanisms.

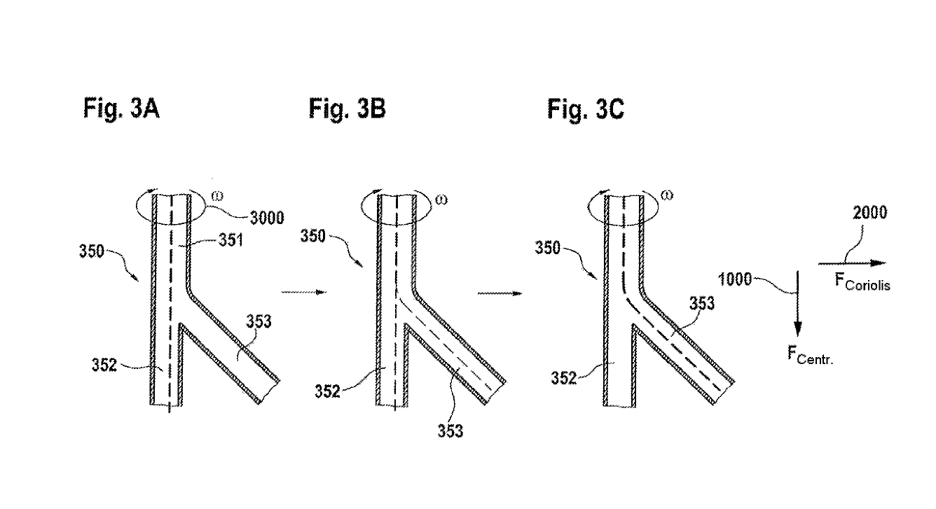

FIGS. 3A-3C schematically shows the diversion of a fluid jet owing to the acting Coriolis force within a duct structure 350 according to the disclosure, which acts as a fluid switch. The figures show the inflow duct 351 and the outflow ducts 352 and 353. The dashed line in each case indicates the fluid path. The centrifugal force acts from top to bottom, as indicated by the arrow 1000. The Coriolis force acts in a transverse direction indicated by the arrow 2000. The direction of rotation of centrifugation is indicated by the arrow 3000. For as long as the centrifugal force 1000 is dominant, no further diversion of the fluid path takes place. The fluid is conducted through the outflow duct 352 (FIG. 3A). With increasing rotational speed, the Coriolis force 2000 comes increasingly to bear. The fluid jet is partially diverted by the Coriolis force 2000, such that the jet is divided up in different ratios, in a manner dependent on the acting Coriolis force, into the forked outflow ducts 352 and 353 (FIG. 3B). When the Coriolis force 2000 becomes fully dominant, the entire fluid jet is diverted transversely and is discharged via the outflow duct 353 (FIG. 3C). Through suitable adjustment of the rotational speeds, the action of the Coriolis force can be controlled, such that the fluid path is conducted into one or the other outflow duct or is divided up between the two outflow ducts in a particular ratio. The simple branch of the outflow ducts 352, 353 shown here can be expanded to include further outflow ducts.

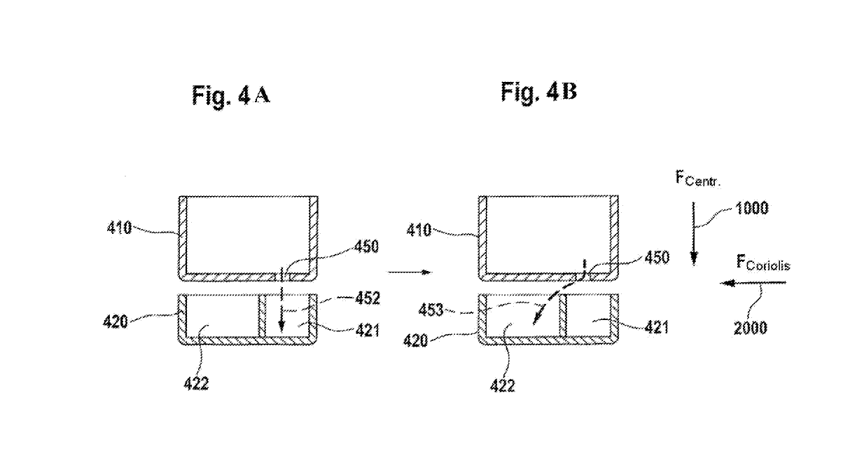

In a further refinement of the disclosure, the fluid switch according to the disclosure may be formed by an opening in the downstream, lower part of a cavity, as illustrated in FIGS. 4A and 4B. The illustrations show an upper body 410 and a lower body 420. On the base of the upper body 410 there is provided an opening 450 through which the fluid runs owing to the acting centrifugal force 1000. For as long as the Coriolis force 2000 is not dominant, the fluid is not diverted and passes, in accordance with the fluid path profile 452, into a chamber 421 situated directly below (FIG. 4A). When the Coriolis force 2000 becomes dominant, the fluid is diverted transversely and passes, in accordance with the fluid path profile 453, into a different chamber 422 of the body 420 (FIG. 4B). Here, the two chambers 421 and 422 of the body 420 are to be understood merely as being exemplary. It is also possible for a greater number of separate chambers to be provided, or for the fluid jet to be diverted into different chambers in different ratios.

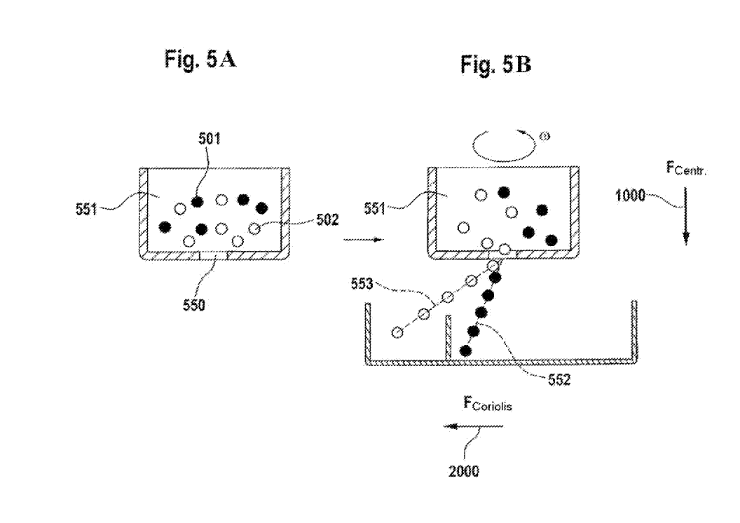

Since the action of the Coriolis force on the diversion of a fluid jet is dependent on the density of the medium, it is also possible on the basis of this principle to realize a separation of different materials, in particular liquids or solids, of different density or mass. This is indicated schematically in FIGS. 5A and 5B. Here, a flowable medium is situated in a cavity 551. The cavity 551 corresponds in terms of function to the inflow duct 151 or 251 in the embodiments illustrated in FIGS. 2A and 2B. The flowable medium in the cavity 551 contains various solids 501 and 502 which each have a different density. The flowable medium emerges from an opening 550 on the base of the cavity 551. In a manner dependent on the acting centrifugal force 1000 and the acting Coriolis force 2000, the solids 501, 502 are, as they emerge, diverted on two different paths 552 and 553 owing to the different densities, and can be separated in this way (FIG. 5B). It is for example possible in this way for beads or particles to be separated out from a liquid or concentrated. Furthermore, it is possible for different constituents of blood (blood cells and blood plasma) to be separated, or for cells of different size to be separated. For the separation of liquids or solids of different density or mass, it is advantageous for the surface tension of the medium to be relatively low.

What is claimed is:

1. A centrifugable device for handling fluids, comprising:
at least two bodies arranged axially one above the other, the at least two bodies each having at least one cavity with the at least one cavity of one body being configured to be fluidically coupled to the at least one cavity of the other body; and
at least one fluid path having an orientation that runs in a manner dependent on an acting Coriolis force.

2. The device according to claim 1, wherein the at least one fluid path acts as a fluid switch so as to provide two or more alternative fluid path profiles.

3. The device according to claim 1, wherein the at least one fluid path is configured in the form of ducts.

4. The device according to claim 3, wherein the ducts have a branched structure with one inflow duct and at least two outflow ducts.

5. The device according to claim 1, wherein the at least one fluid path is configured in the form of an opening.

6. The device according to claim 1, wherein, through the at least one fluid path, fluids are configured to be diverted into different cavities in a manner dependent on the acting Coriolis force.

7. The device according to claim 1, wherein, through the at least one fluid path, fluids are configured to be diverted into different cavities in different proportions in a manner dependent on the acting Coriolis force.

8. The device according to claim 1, wherein, through the at least one fluid path, solid or liquid or gaseous constituents of fluids, which have different densities, are configured to be diverted into different cavities in a manner dependent on the acting Coriolis force.

9. The device according to claim 1, wherein the device is configured to carry out one or more of a chemical process and a biochemical process.

10. The device according to claim 1, wherein the device is configured for use in a rotor of a centrifuge.

11. The device according to claim 1, wherein the at least two bodies are configured to be displaced or rotated relative to one another in a manner dependent on a centrifugal force or on an equivalent force, and wherein, for the rotation of the bodies relative to one another, provision is made for guide springs of one body to engage into a profile tooth row on the other body, and of a restoring force, which acts counter to the centrifugal force or counter to the equivalent force, of the bodies.
